(19) United States
(12) Patent Application Publication
(10) Pub. No.: US 2023/0105420 A1
(43) Pub. Date: Apr. 6, 2023

(54) RESILIENT DIRECT PART MARKING ON CARBON STEEL USING LASER ENGRAVING AND COATING PROCESSES

(71) Applicant: Operations Technology Development, NFP, Des Plaines, IL (US)

(72) Inventors: William Gale, Palm Coast, FL (US); Kenneth Skorenko, Endicott, NY (US); William E. Bernier, Endicott, NY (US)

(73) Assignee: Operations Technology Development, NFP, Des Plaines, IL (US)

(21) Appl. No.: 17/958,568

(22) Filed: Oct. 3, 2022

Related U.S. Application Data
(60) Provisional application No. 63/251,881, filed on Oct. 4, 2021.

(51) Int. Cl. G06K 19/06; B23K 26/362; B05D 7/14; C09D 5/08

(52) U.S. Cl. CPC G06K 19/06121; B23K 26/362; B05D 7/14; C09D 5/084; B05D 2202/00

(57) ABSTRACT

A computer readable barcode on a surface of a corrodible material, and method of forming. A surface depression of an inverse bar code pattern is etched or engraved within the surface and around the code elements. A corrosion-resistant material is cured within the surface depression formed by the engraving. The corrosion-resistant material is lightly colored to frame the formed barcode lines.

### CROSS REFERENCE TO RELATED APPLICATION

This application claims the benefit of U.S. Provisional Patent Application Ser. No. 63/251,881, filed on 4 Oct. 2021. The co-pending provisional application is hereby incorporated by reference herein in its entirety and is made a part hereof, including but not limited to those portions which specifically appear hereinafter.

### BACKGROUND OF THE INVENTION

### Field of the Invention

This invention relates generally to controlled laser engraving processes and, more particularly, to laser engraved and coating systems for applications to improve corrosion resistance, and/or to preserve optical contrast and readability of barcodes.

### Description of Related Art

Conventional image processing software is used to scan and read barcodes. Such software can be found and used on a variety of devices such as phones, barcode scanners, tablet computers, and other smart devices. Barcodes can be placed on a variety of items and mediums from paper to plastic, to metal, and other materials. Barcodes are also used in a wide variety of industries to identify items, parts, and programs, etc. Whether barcodes are used on a residential, commercial, or industrial level, readability of said barcodes by an image-processing software is essential. Current barcodes may be laser engraved on carbon steel, for example, but are only readable for a short period of time (often an hour or less) under non-arid weathering conditions. Therefore, improved laser marking processes are desired so that barcodes can have a longer life of readability, particularly when barcodes are exposed to outdoor elements.

### SUMMARY OF THE INVENTION

The invention generally relates to laser engraving processes. The general object of the invention can be attained, at least in part, through coating systems to inhibit corrosion, and application processes to apply these coating systems to build a corrosion and abrasion resistant layer that enhances and preserves the computer readable code's optical contrast, durability, and readability. The computer readable code, such as barcodes, according to the present invention are easily read with conventional image processing software found in smart devices such as phones, barcode scanners, and tablet computers. The barcodes created with these processes can be readable for periods of time measured in years as opposed to a simple barcode engraved on carbon steel according to the prior art, which may only be readable for an hour or less in normal weathering conditions.

Embodiments of this invention include a method of engraving a computer readable code on a corrodible material. The method includes: engraving (e.g., laser etching) a code pattern into a surface of the corrodible material; applying a corrosion-resistant material to the engraved code pattern; and curing the corrosion-resistant material within the engraved code pattern. The code pattern is desirably an inverse code pattern, wherein the engraving creates a surface depression or cavity about the intended computer readable code. For example, the code pattern can be an inverse barcode, wherein the engraving cavity provides the ‘white space’ around the non-engraved barcode lines.

In preferred embodiments, the corrosion-resistant material includes a contrasting color to the surface, such as to assist in making the barcode readable. The corrosion-resistant material can include TiO₂ or ZnO particles, as well as a binder and a photo-initiator, collectively in a solvent to form an ink or epoxy for application.

In embodiments of this invention, the method includes partially removing the cured corrosion-resistant material within the engraved code pattern, such as by a second engraving of the code pattern.

In embodiments of this invention, the method includes applying and curing an abrasion-resistant layer to the engraved code pattern. The corrosion-resistant material and/or the abrasion-resistant material can be sprayed over the code pattern, such as filling any remaining depression or cavity left by the first or second engraving, and then laser cleaned on, in, and/or around the engraved code pattern. In embodiments, the abrasion-resistant layer has a slight crown over the entire barcode.

The invention further includes a method of engraving a computer readable code on a corrodible material, including steps of: engraving an inverse code pattern into a surface of the corrodible material; applying a corrosion-resistant material within an engraved surface depression about the inverse code pattern; curing the corrosion-resistant material within the engraved code pattern; and removing a surface portion of the cured corrosion-resistant material by engraving the inverse code pattern, or a second pattern (e.g., a same general pattern with different engraving dimensions), within the cured corrosion-resistant material.

The invention further includes a computer readable code on a surface of a corrodible material, such as made by any of the methods and materials described herein. The computer readable code includes a surface depression of an inverse code pattern within the surface and around the code. A corrosion-resistant material is cured within the surface depression. Again, the corrosion-resistant material desirably provides a contrasting color to the original surface to assist in computer scanning.

Other objects and advantages will be apparent to those skilled in the art from the following detailed description taken in conjunction with the appended claims.

### BRIEF DESCRIPTION OF THE DRAWINGS

FIG. 1 shows a plan view of a computer readable code according to one embodiment of this invention.

FIG. 2 is a section view of FIG. 1.

### DETAILED DESCRIPTION OF THE INVENTION

The present invention provides a laser engraving process for computer readable codes, such as barcodes, QR codes, or equivalents, where direct part marking of carbon steel is performed instead of labels or wired on corrosion-resistant metal tags. Direct part marking is preferred where regulations require traceability to supporting quality control inspection and test reports.

The present invention also provides coating systems that inhibit corrosion, and application processes to apply said coating systems to build a corrosion and abrasion resistant layer for a barcode. The abrasion resistant layer enhances and preserves barcode optical contrast and readability. The barcodes detailed in these processes can be read with conventional image processing software found in smart devices such as phones, barcode scanners, and tablet computers, among others. The barcodes created according to the subject invention may remain readable for years, as opposed to the techniques of the prior art where barcodes are only readable for a short period of time, potentially measured in hours, in normal weathering conditions.

As such, a preferred method of operation of the subject invention includes providing a barcode on a corrosive substrate, namely carbon steel. A corrosion-resistant layer is then added to the barcode on the carbon steel. The corrosion resistant layer is then partially removed using the laser system, enhancing the contrast of the barcode. An abrasion-resistant layer is likewise added to the barcode on the carbon steel and UV (ultra-Violet) cured to harden the coating.

Embodiments of the subject invention include an intelligent barcode on a fundamentally corrosive substrate providing long term storage of data for mapping and record keeping. Generally, barcodes are laser engraved on substrates with low oxidation potential, such as stainless steel, aluminum, and brass. Carbon steel is not marked with laser engraved barcodes unless the component is in an environment that is protected from corrosive agents. The subject invention extends the use of laser engraving barcode data on carbon steel or other corrodible materials, in environments that are subject to corrosion such as marine environments and normal outdoor weathering conditions.

The processes according to the subject invention extend the use and availability of laser engraved barcode data, while keeping the mechanical properties of the engraved steel intact. In some embodiments of the invention, the engraving process removes from 2 to 5 mils of material. Current laser engraving processes for production are generally limited to 1 to 1.5 mils, and light abrasion can be used to completely remove the barcode if desired.

A preferred method according to the subject invention for engraving barcodes includes engraving an inverse barcode pattern, wherein the corrodible substrate comprises carbon steel. Next a corrosion-resistant ink layer is added to the carbon steel. Next, the corrosion resistant ink layer is cured to harden surface. The corrosion-resistant ink layer is partially removed using the inverse barcode pattern, and preferably a scaled-down version of the pattern. Next an abrasion-resistant top layer is added to the barcode on carbon steel. Finally, the abrasion resistant layer is UV cured to harden the surface.

Laser etching of an inverse barcode creates one or more wells on the corrosive substrate. The wells preferably mimic the pattern of the white background portion of a barcode and are filled, generally to even with the surface, with an anti-corrosion material. The anti-corrosion layer may be added by aerosol spray onto the corrosive substrate. The barcode pattern is restored as needed from the spraying process in the above steps by using a laser cleaning process to remove all over-spray and to sharpen optical contrast. An aerosol spray of anti-abrasion formulation may then be applied. In addition, a rapid cure anti-abrasion formulation may be utilized in the above method.

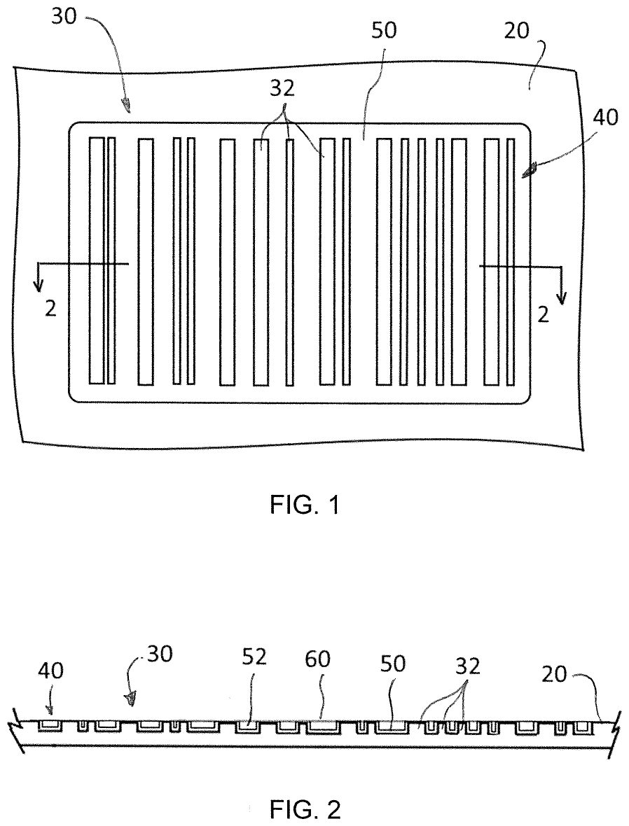

FIGS. 1 and 2 shows a material surface 20 including a computer readable code, namely a barcode 30, engraved in the surface 20. The material surface can be any suitable surface, and the invention is particularly suited for easily corrodible material, such as carbon steel or other unprotected metal. The barcode 30, and each barcode line 32, are formed by engraving or etching away material around the lines 32 to form a surface depression 40. The surface depression 40 surrounds and outlines the periphery of the barcode lines 32, and acts as the background ‘white space’ generally known to be around a printed barcode. The depression 40 together with the resulting ‘raised’ lines 32 form an inverse, three-dimensional barcode pattern. As will be appreciated, various sizes, shapes, and configurations are available for the surface depression and barcode lines. For example, instead of a continuous depression 40 extending around opposing ends of the lines 32, the bar code can be formed a plurality of parallel, spaced apart depression lines or strips between and/or adjacent sides of the individual barcode lines.

In exemplary embodiments of this invention, the laser etching is performed using a fiber laser, such as at 100 watts and 1064 nm. An exemplary laser operation includes the following parameters: a linewidth of 0.001 to 0.01 inch, 1 to 50 passes at 45°, 90°, 135° and/or 180°, a scan speed of 50 to 2000 inches/sec, a laser frequency of 65 to 100 Hz using a Q factor of 100 to 500 at a power percentage of 60% to 100%, a laser wobble of 0 to 2 in at a frequency of up 300 Hz, and an inline etch for the barcode of up to 0.01 inch.

A corrosion-resistant material 50 is applied and cured within the surface depression 40. The corrosion-resistant material 50 is desirably formed of a contrasting color material, such as a light colored material that contrasts the barcode line 32 color to form a readable barcode 30. In embodiments of this invention, the corrosion-resistant material 50 includes a white-colorant, preferably that is also the corrosion inhibitor, such as TiO2 or ZnO.

In embodiments, the corrosion-resistant material 50 is applied as an ink including a corrosion inhibitor, a binder, and a photo-initiator, all within a solvent. After curing, the corrosion-resistant material 50 desirably fills the surface depression 40 to cover all exposed engraved surfaces. In embodiments of the invention, the corrosion-resistant material 50 is further engraved, such as by laser etching, to remove a surface portion of the corrosion-resistant material 50 to form a further depression 52 between and desirably all around the barcode lines 32. The engraving/etching of the corrosion-resistant material 50 can be performed according to the original depression 40 pattern, except on an adjusted scale to leave all surfaces covered within the depression 40.

In embodiments, an abrasion-resistant layer 60 is applied to the barcode 30, to increase the hardness of the barcode 30 and depression 40. The abrasion-resistant layer 60 is desirably applied on and over the engraved corrosion-resistant material 50. In embodiments, the abrasion-resistant layer 60 is sprayed onto the barcode 30, desirably filling further depression 52, and a laser cleaning is used to remove the abrasion-resistant material from the surface 20 of the corrodible material within and/or around the barcode 30. In embodiments of this invention, the abrasion-resistant layer 60 preferably fills any remaining cavity between or around the barcode lines, however, the abrasion-resistant layer 60 can also leave a portion of the depression remaining or provide a slight crowning (e.g., 1-2 mils) over the barcode.

The corrosion-resistant material includes a corrosion inhibitor. In embodiments of this invention, the corrosion inhibitor also provides a contrasting color to the etched surface. For example, a white color can be provided with one or more of ZnO (e.g., 0-30%) and/or TiO₂ (e.g., 0-30%). The size of inhibitor particles are preferably 0.5 to 60 μm in size. One preferred corrosion-resistant material includes 20 wt. % ZnO using 5 μm particles.

The corrosion-resistant material of embodiments of this invention further includes a solvent. Exemplary solvents include, without limitation, one or more of chloroform, xylene, benzene, acetone, cyclohexane, and/or toluene. The solvent desirably embodies 10 to 60 wt. % of the corrosion-resistant material formulation. One preferred corrosion-resistant material ink includes approximately 37.5 wt. % acetone. The corrosion-resistant material of embodiments preferably includes a binder, such as, without limitation, polyacrylate, polyurethane, and/or epoxy, such as at 0 to 60 wt. %, and most preferably at approximately 37.5 wt. %. The corrosion-resistant material of embodiments preferably includes a photo-initiator, such as, without limitation: 2,2-Dimethoxy-1,2-diphenylethan-1-one; diphenyl (2,4,6-trimethyl benzoyl) phosphine oxide; and/or 2-hydroxy-2-methylpropiophenone, such as at 10 to 30 wt. % in solution. The photo-initiator solution is added as 1 to 10 wt. % of the corrosion-resistant material ink formulation, and most preferably is 5 wt. % of diphenyl (2,4,6-trimethyl benzoyl) phosphine oxide in solution.

In embodiments of the invention, the anti-abrasion layer formulation preferably includes a binder and photo-initiator, together in a solvent. Exemplary binders include, without limitation, polyacrylate, polyurethane, and/or epoxy, such as at up to 65 wt. %. One preferred binder is aliphatic urethane acrylate, at around 62.7 wt. %. Exemplary solvents include, without limitation, one or more of chloroform, xylene, benzene, acetone, cyclohexane, or toluene, such as at 10 to 60 wt. % of the formulation. One preferred solvent is acetone, at about 32.3 wt. %. Exemplary photo-initiators include: 2,2-Dimethoxy-1,2-diphenylethan-1-one; diphenyl (2,4,6-trimethyl benzoyl)phosphine oxide; and/or 2-hydroxy-2-methylpropiophenone, such as at 10 to 30 wt. % in solution. The photo-initiator solution is added as 1 to 10 wt. % of the corrosion-resistant material ink formulation, and most preferably is 5 wt. % of diphenyl (2,4,6-trimethyl benzoyl) phosphine oxide in solution.

In embodiments, the corrosion-resistant material and/or the anti-abrasion layer are applied by aerosol spray, followed by a surface cleaning process. The aerosol spray process preferably uses a low volume, low pressure spray, such as set to 20 to 100 psi, and sprayed for 2 to 20 seconds at a distance of 10 to 30 cm. Example embodiments where made using a 30 psi, 2.4 to 3.3 CFM spray gun, with a 0.8 mm diameter nozzle with a 0.25 inch air inlet on the spray gun. The spryer distance was preferably approximately 20 cm and the formulation was sprayed for 4 seconds, depositing approximately 30 g of material, of which approximately 0.1125 g evaporated. The applied material is then cured, such as using ultraviolet curing, such as with a 100 watt mercury lamp for 2 to 60 seconds. In preferred embodiments the curing is at 14 seconds at a distance of 10 cm.

In embodiments, a laser cleaning process restoring the barcode pattern from the application of the anti-corrosive material spray is preferably accomplished using the fiber laser discussed above. The cleaning can also include removing a portion of the cured corrosion-resistant material within the engraved code pattern, such as to lower the level of the anti-corrosive material within the initial engraving cavity. The anti-abrasion layer is applied to the barcode using an aerosol spray discussed above, and rapid curing of the anti-abrasion formulation can be performed using a mercury lamp for 2 to 60 seconds until surface has hardened.

### EXAMPLES

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples. Specific preferred settings for the etching and cleaning are as follows:

### Clean Surface—Hatch Fill and Outline

Line width: 0.005 in
Passes: 10
Angles: 90° and 180°
Speed: 350 in/sec
Frequency: 67
Q factor: 350
Power: 100%
Wobble/Wobble Freq: 0/0
Inline: 0

### Deep Engraving—Hatch Fill and Outline

Line width: 0.0008 in
Passes: 3
Angles: 45°, 90°, 135°, and 180°
Speed: 90 in/sec
Frequency: 67
Q factor: 300
Power: 100%
Wobble/Wobble Freq: 0/0
Inline: 0

### Final Clean—Hatch Fill and Outline

Line width: 0.005 in
Passes: 1
Angles: 90° and 180°
Speed 350 in/sec
Frequency: 67
Q factor: 350
Power: 100%
Wobble/Wobble Freq: 0/0
Inline: 0

Thus the invention provides an improved computer readable code for application to surface of a corrodible material. The etched computer readable code provides a long-lasting surface code, while maintaining desirably structural and corrosion features.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of engraving a computer readable code on a corrodible material, the method comprising:
engraving a code pattern into a surface of the corrodible material;
applying a corrosion-resistant material to the engraved code pattern; and
curing the corrosion-resistant material within the engraved code pattern.

2. The method of claim 1, wherein the corrosion-resistant material includes a contrasting color to the surface.

3. The method of claim 2, wherein the corrosion-resistant material comprises TiO₂ or ZnO.

4. The method of claim 3, wherein the corrosion-resistant material comprises a binder and a photo-initiator.

5. The method of claim 1, further comprising:
partially removing the cured corrosion-resistant material within the engraved code pattern.

6. The method of claim 5, wherein the corrosion-resistant material comprises an ink layer, and further comprising:
removing a portion of the cured corrosion-resistant material within the engraved code pattern using by a second engraving of the code pattern.

7. The method of claim 5, further comprising:
applying an abrasion-resistant layer to the engraved code pattern.

8. The method of claim 1, further comprising:
adding an abrasion-resistant layer to the engraved code pattern; and
curing the abrasion resistant layer to harden the surface.

9. The method of claim 8, further comprising:
spraying the abrasion-resistant layer onto the surface; and
laser cleaning the abrasion-resistant layer around the engraved code pattern.

10. The method of claim 1, wherein the code pattern is an inverse code pattern, wherein the engraving creates a surface depression or cavity about the computer readable code.

11. The method of claim 10, wherein the code pattern comprises an inverse barcode.

12. The method of claim 1, wherein the engraving comprises laser etching.

13. A method of engraving a computer readable code on a corrodible material, the method comprising:
engraving an inverse code pattern into a surface of the corrodible material;
applying a corrosion-resistant material within an engraved surface depression about the inverse code pattern;
curing the corrosion-resistant material within the engraved code pattern; and
removing a surface portion of the cured corrosion-resistant material by engraving the inverse code pattern within the cured corrosion-resistant material.

14. The method of claim 13, wherein the corrosion-resistant material includes a contrasting color to the surface.

15. The method of claim 14, wherein the corrosion-resistant material comprises TiO₂ or ZnO, and the contrasting color is white.

16. The method of claim 13, wherein the corrosion-resistant material is applied as an ink including a corrosion inhibitor, a binder, and a photo-initiator, within a solvent.

17. The method of claim 13, further comprising:
applying an abrasion-resistant layer to the engraved corrosion-resistant material; and
curing the abrasion resistant layer to harden the surface.

18. The method of claim 17, further comprising:
spraying the abrasion-resistant layer onto the surface and the engraved corrosion-resistant material; and
laser cleaning the abrasion-resistant layer from the surface around the engraved inverse code pattern.

19. The method of claim 18, wherein the computer readable code is a barcode and the code pattern comprises an inverse barcode.

20. A computer readable code on a surface of a corrodible material, comprising a surface depression of an inverse code pattern within the surface and around the code, and a corrosion-resistant material cured within the surface depression.
